(19) United States
(12) Patent Application Publication
(10) Pub. No.: US 2005/0248139 A1
(43) Pub. Date: Nov. 10, 2005

(54) Trim pad assembly

(76) Inventor: Glen D. Schmidt, New Baltimore, MI (US)

Correspondence Address: David J. Simonelli, Esq.;Clark Hill PLC, Suite 3500, 500 Woodward Ave., Detroit, MI, 48226-3435, US

(21) Appl. No.: 10/840,551

(22) Filed: May 6, 2004

(51) Int. Cl. B60R 21/045

(52) U.S. Cl. 280/752

(57) ABSTRACT

A trim pad assembly provides a cover to a watershield and a door frame of an automobile. The automobile includes a passenger compartment that is accessible through the door frame. The trim pad assembly includes an inboard decorative surface facing the passenger compartment when the door frame is in the closed position with respect to the automobile. The trim pad assembly also includes an outboard surface defining a periphery. The periphery is fixedly secured to the door frame. The trim pad assembly also includes a relief that extends about the periphery. The relief receives the watershield therein when the trim pad assembly is fixedly secured to the door frame such that the trim pad and the watershield prevent water from passing through the watershield and into and past the trim pad assembly.

### BACKGROUND ART

1. Field of the Invention

The invention relates to a trim pad assembly for a vehicular door. More particularly, the invention relates to a trim pad assembly incorporating a watershield wherein the watershield is retained with the trim pad assembly without the use of an adhesive.

2. Description of the Related Art

Automobiles include doors that have trim pads covering the inboard surface of the door. The trim pads are decorative and are usually fabricated of the same material as the interior upholstery or carpet of the automobile. While it may appear that the trim pad has the sole purpose of being decorative, the trim pad assembly has a multi-functioning task. The trim pad must be aesthetically pleasing to the operator of the automobile. In addition, the trim pad is used to reduce road noise. Still another function of the trim pad assembly is to prevent the elements from passing through the door and into the passenger compartment. The trim pad assembly covers the door and, more particularly, the door frame, that has several apertures extending therethrough allowing for the mounting and accessing of subsystems within the door.

A part of the door includes a watershield that prevents water from passing from the interior portion of the door to the trim pad. The watershield prevents water from discoloring and, eventually destroying the look of the trim pad assembly. The watershield is cumbersome to work with and is secured to either the trim pad assembly or the door frame. This requires additional man hours to assemble the door and can create problems during the maintenance of the subsystems within the door due to the difficulty of adhering the watershield to another structure a second time.

### SUMMARY OF THE INVENTION

A trim pad assembly provides a cover to a watershield and a door frame of an automobile. The automobile includes a passenger compartment that is accessible through the door frame. The trim pad assembly includes an inboard decorative surface facing the passenger compartment when the door frame is in the closed position with respect to the automobile. The trim pad assembly also includes an outboard surface defining a periphery. The periphery is fixedly secured to the door frame. The trim pad assembly also includes a relief that extends about the periphery. The relief receives the watershield therein when the trim pad assembly is fixedly secured to the door frame such that the trim pad and the watershield prevent water from passing through the watershield and into and past the trim pad assembly.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of a passenger compartment of an automobile with a door incorporating one embodiment of the invention;

FIG. 2 is an exploded view of the invention;

FIG. 3 is an exploded, cross-sectional, side view of the invention; and

FIG. 4 is a cross-sectional side view of the invention fixedly secured to a door, both of which are partially cut away.

### DETAILED DESCRIPTION OF THE PREFERRED EMBODIMENT

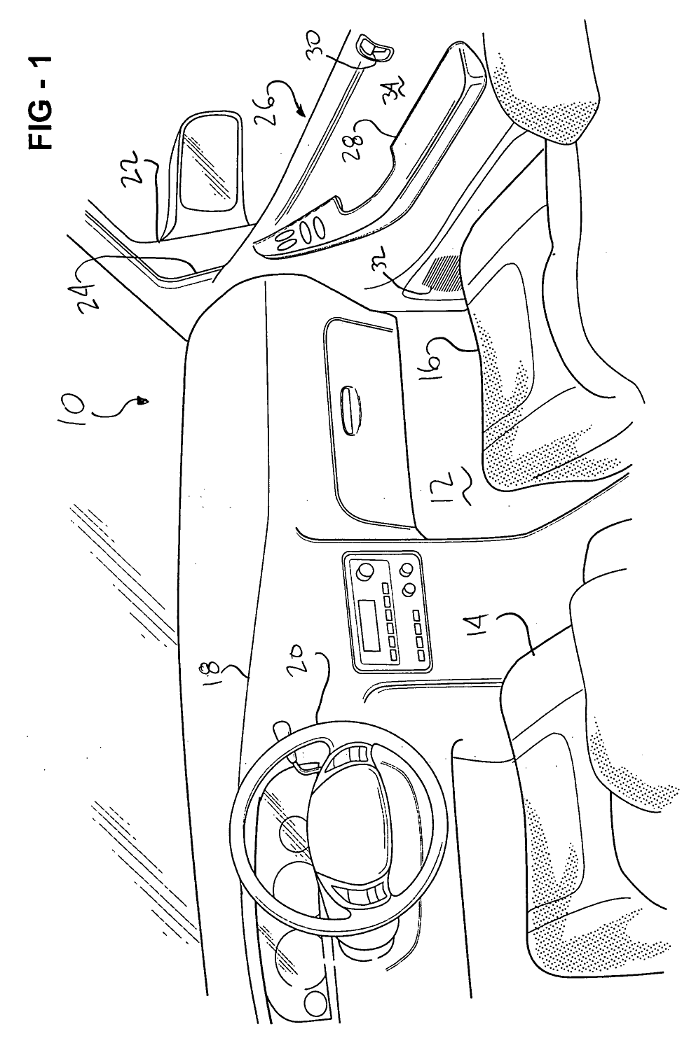

Referring to the FIG. 1, a perspective view of an automobile is generally indicated at 10. The automobile 10 includes a passenger compartment 12 having a driver's seat 14 and a passenger seat 16. The passenger compartment 12 also includes an instrument panel 18 and a steering wheel 20. Access to the passenger compartment 12 is provided by a door 22 that includes a door frame 24. As is known in the art, the door 22 is selectively opened and closed to provide access to the passenger compartment 12.

The door 22 also includes a trim pad assembly 26. The trim pad assembly 26 has a door handle/arm rest 28 fixedly secured thereto. Additional subsystems of the automobile 10 that are secured to the door 22 and have access through the trim pad assembly 26 include a door lock knob 30 and a speaker 32. As should be appreciated by those skilled in the art, there may be several other types of subsystems that are secured to the door frame 24 and are covered by or extend through the trim pad assembly 26.

The trim pad assembly includes an inboard decorative surface 34. The inboard decorative surface typically includes a cover of the same material or fabric that is used throughout the passenger compartment 12. For aesthetic reasons, the inboard decorative surface 34 is typically not fabricated from a material that will provide a shield from water and any other type of dirt or debris that might be collected within the door frame 24 of the door 22.

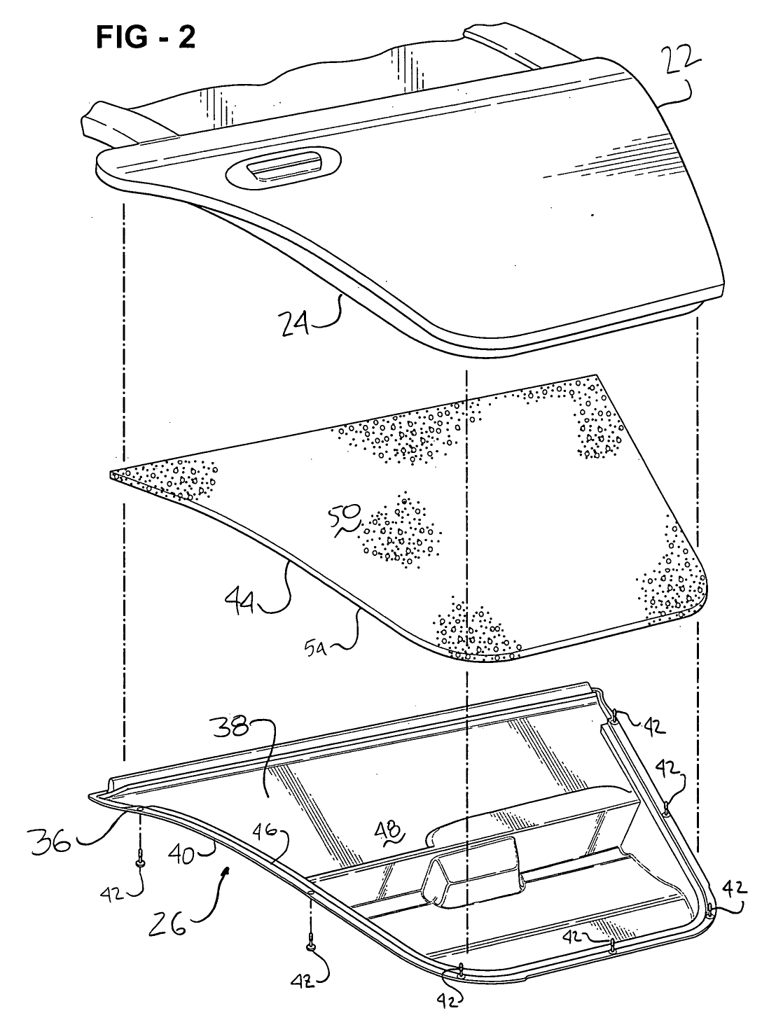

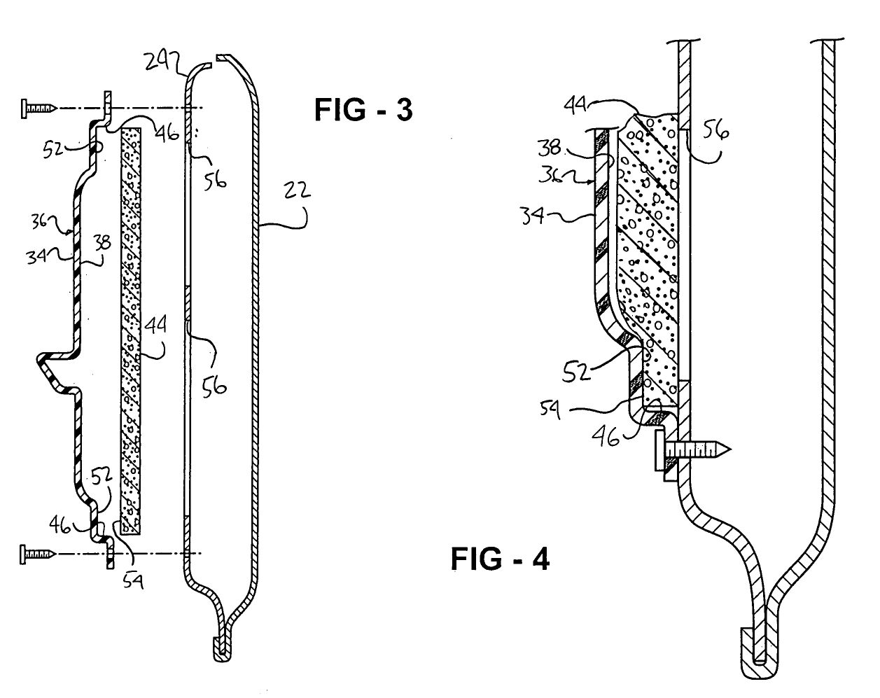

Referring to FIG. 2, the trim pad assembly 26 includes a trim pad 36. The inboard decorative surface 34 defines one surface of the trim pad 36. Another surface of the trim pad 36 is the outboard surface 38. Because the trim pad 36 is fabricated from a polypropylene, the outboard surface 38 typically has a similar contour to the inboard decorative surface 34. The outboard surface 38 faces the door frame 24 of the door 22.

The outboard surface 38 defines a periphery 40 extending thereabout. A plurality of fasteners 42 are spaced about the periphery 40 and are used to secure the trim pad 36 to the door frame 24. In the preferred embodiment shown in FIG. 2, the fasteners 42 are screws.

A watershield 44 extends between the outboard surface 38 of the trim pad 36 and the door frame 24. The watershield 44 may extend across an entire surface defined by the trim pad 36 or merely a portion thereof. The watershield 44 prevents water and other debris from passing through the door 22 and reaching the trim pad 36. The watershield 44 is typically fabricated from expanded, cross-linked, micro-cellular polypropylene, polyethylene and urethanes. These materials have excellent compression set resistance, which is critical for a long term seal.

The periphery 40 of the outboard surface 38 includes a relief 46. The relief 46 extends about a portion of the periphery 40 and receives the watershield 44 therein when the trim pad assembly 26 is fixedly secured to the door frame 24. The relief 46 defines a relief area 48 that is substantially similar to a surface area 50 defined by the watershield 44. In fact, the surface area 50 in the relief area 48 are so congruous that the watershield 44 is snap fit into the trim pad 36.

Disposed adjacent the relief 46 is a shield abutting surface 52. An outer periphery 54 of the watershield 44 abuts the shield abutting surface 52. When the fasteners 42 tighten the trim pad 36 against the door frame 24, a seal is created between the watershield 44 and the door frame 24 preventing water and other debris from passing through any apertures 56 that may be found within the door frame 24 and, hence, preventing the water and debris from reaching the trim pad 36.

In operation, the watershield 44 is oriented over the trim pad 36. Once the trim pad 36 and watershield 44 have the same orientation, the watershield 44 is snap fit into the relief 46 of the trim pad 36. This is all done pre-assembly thus reducing man-hours during vehicle manufacturing. This also eliminates space on assembly lines making the vehicle manufacture more efficient. The snap fit of the watershield is sufficient to hold the watershield 44 in place in the trim pad 36 so that the trim pad assembly 26 can be treated as a single unit for subsequent installation without regard to positioning the watershield 44 during the assembly of the automobile 10. Once the trim pad assembly 26 is in place with respect to the door frame 24, the fasteners 42 secure the trim pad assembly 26, including the trim pad 36 and the watershield 44 in place.

Should maintenance be required on the subassemblies in the door 22, removal of the fasteners 42 allow the trim pad assembly 26 to be removed. The watershield 44 is removed with the trim pad assembly 26. Upon completion of the maintenance the watershield 44 is put back in place exactly the way it is preventing the opportunity for new leaks to be created due to contamination or damage through the handling of the glue bead seal.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

1. A trim pad assembly for providing a cover to a watershield and a door frame of an automobile having a passenger compartment accessible via the door frame, said trim pad assembly comprising:
an inboard decorative surface facing the passenger compartment when the door frame is in a closed position;
an outboard surface defining a periphery, said periphery fixedly secured to the door frame; and
a relief extending about a portion of said periphery to receive the watershield therein when said trim pad assembly is fixedly secured to the door frame such that said trim pad assembly and the watershield prevent water from passing through the watershield.

2. A trim pad assembly as set forth in claim 1 including a shield abutting surface extending inwardly from said relief, said shield abutting surface receiving the watershield thereagainst.

3. A trim pad assembly as set forth in claim 2 including a plurality of fasteners spaced about said periphery to fixedly secure said trim pad assembly to the door frame.

4. A trim pad assembly as set forth in claim 2 including a plurality of fasteners spaced about said shield abutting surface to fixedly secure said trim pad assembly to the door frame.

5. A trim pad assembly for providing a cover to a door frame of an automobile having a passenger compartment accessible via the door frame, said trim pad assembly comprising:
an inboard decorative surface facing the passenger compartment when the door frame is in the closed position;
an outboard surface defining a periphery, said periphery fixedly secured to the door frame, said outboard surface including a relief defining a relief area and a shield abutting surface; and
a watershield having a surface area substantially conforming to said relief area, said watershield snap fit against said relief such that said relief holds said watershield against said trim pad.

6. A trim pad assembly as set forth in claim 5 including a plurality of fasteners spaced about said periphery to fixedly secure said trim pad assembly to the door frame.

7. A trim pad assembly as set forth in claim 5 including a plurality of fasteners spaced about said shield abutting surface to fixedly secure said trim pad assembly to the door frame.
